(19) United States
(12) Patent Application Publication
(10) Pub. No.: US 2025/0224880 A1
(43) Pub. Date: Jul. 10, 2025

(54) TECHNIQUES FOR MEMORY CELL DEGRADATION PROTECTION

(71) Applicant: Micron Technology, Inc., Boise, ID (US)

(72) Inventors: Zhongguang Xu, San Jose, CA (US); Peng Zhang, Los Altos, CA (US); Murong Lang, San Jose, CA (US)

(21) Appl. No.: 19/011,067

(22) Filed: Jan. 6, 2025

Related U.S. Application Data
(60) Provisional application No. 63/618,735, filed on Jan. 8, 2024.

(51) Int. Cl. G06F 3/06

(52) U.S. Cl. CPC G06F 3/0616; G06F 3/064; G06F 3/0653; G06F 3/0679

(57) ABSTRACT

Methods, systems, and devices for techniques for memory cell degradation protection are described. In some cases, a memory system may perform a protection operation on blocks of memory cells in response to monitoring the temperature of the memory system. For example, the memory system may monitor the temperature associated with the system over a duration. If the temperature exceeds a threshold, a counter may be adjusted by a first value. If the counter exceeds a second threshold, the memory system may trigger one or more protection operations on the blocks of memory cells. These protection operations may include programming a data pattern to each block of memory cells.

### CROSS REFERENCE

The present Application for Patent claims priority to U.S. patent application Ser. No. 63/618,735 by Xu et al., entitled “TECHNIQUES FOR MEMORY CELL DEGRADATION PROTECTION,” filed Jan. 8, 2024, which is assigned to the assignee hereof, and which is expressly incorporated by reference in its entirety herein.

### TECHNICAL FIELD

The following relates to one or more systems for memory, including techniques for memory cell degradation protection.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for memory cell degradation protection in accordance with examples as disclosed herein.

FIG. 2 shows an example of a system that supports techniques for memory cell degradation protection in accordance with examples as disclosed herein.

FIG. 3 shows an example of a process flow that supports techniques for memory cell degradation protection in accordance with examples as disclosed herein.

FIG. 4 shows a block diagram of a memory system that supports techniques for memory cell degradation protection in accordance with examples as disclosed herein.

FIG. 5 shows a flowchart illustrating a method or methods that support techniques for memory cell degradation protection in accordance with examples as disclosed herein.

### DETAILED DESCRIPTION

In some memory systems, a block of memory cells may remain in a specific state for a relatively long time, such as an erased state, a partially programmed state, or an open state. An erased block refers to a block of memory cells where all the cells are in an erased state, meaning they contain no stored data. A partially programmed block may be a closed block in which some pages have been programmed while other pages have not been programmed. An open block is a block in which some pages have been programmed with data while others remain unprogrammed. During operation of the memory system, these blocks may undergo periods of high temperatures, which may result in data being erased from a block of memory cells. Additionally, high temperatures may be experienced when the memory system performs operations on other blocks of memory cells. Repeated exposure to high temperatures may lead to permanent degradation of the blocks. For example, this degradation may manifest as a reduction in the read window budget of the blocks. The read window budget may refer to the difference in voltage between voltage distributions corresponding to different logic states. A reduced read window budget can negatively impact the reliability and performance of the memory system and may increase a rate of errors experienced by data stored in the memory system.

As described herein, a memory system may perform a protection operation on blocks of memory cells to mitigate degradation (e.g., during periods of high temperatures). For example, the memory system may monitor the temperature associated with the system over a specific time frame. If the temperature exceeds a certain threshold, a counter is adjusted by a first value. In response to the counter exceeding a second threshold, the memory system triggers protection operations on the blocks of memory cells. These protection operations involve programming a specific data pattern to each block, which may help mitigate degradation caused by exposure to high temperatures.

In addition to applicability in memory systems as described herein, techniques for memory cell degradation protection may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving reliability and longevity of memory systems, which may decrease processing or latency times, improve response times, or otherwise improve user experience, among other benefits.

Features of the disclosure are illustrated and described in the context of systems, devices, and circuits. Features of the disclosure are further illustrated and described in the context of a process flow and flowcharts.

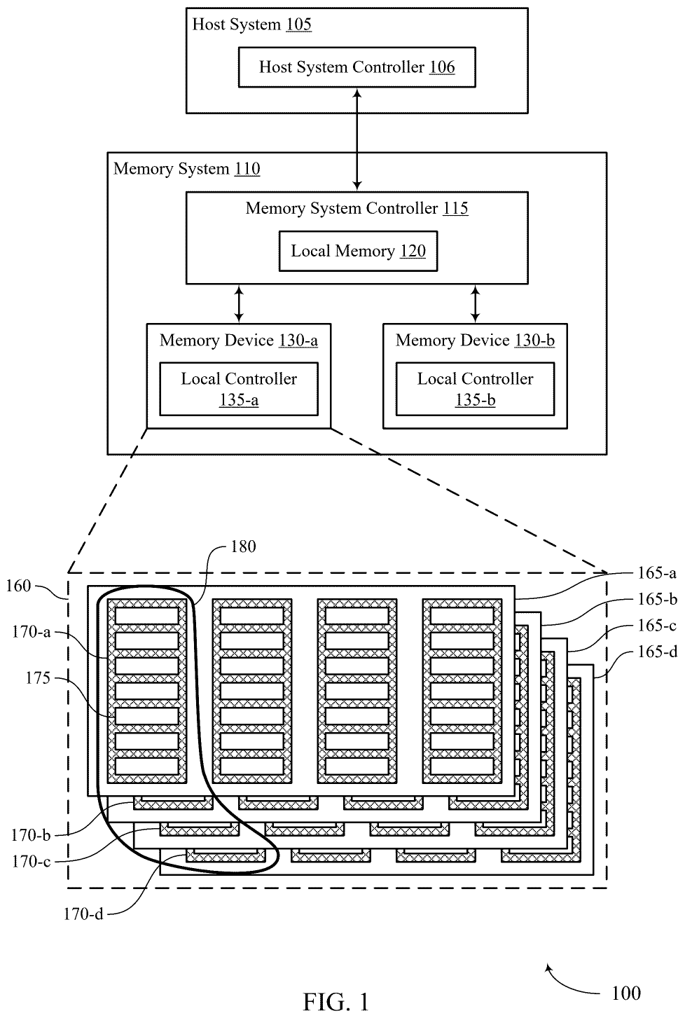

FIG. 1 shows an example of a system 100 that supports techniques for memory cell degradation protection in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (O×RAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support techniques for memory cell degradation protection. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, a memory system 110 may perform a protection operation on blocks 170 to mitigate degradation. For example, the memory system 110 may monitor the temperature associated with the memory system 110 over a duration. If the temperature exceeds a certain threshold, a counter may be adjusted by a first value. If the counter exceeds a second threshold, the memory system 110 may trigger one or more protection operations on the blocks 170. These protection operations may involve programming a specific data pattern to each block 170, which may help mitigate degradation caused by exposure to high temperatures.

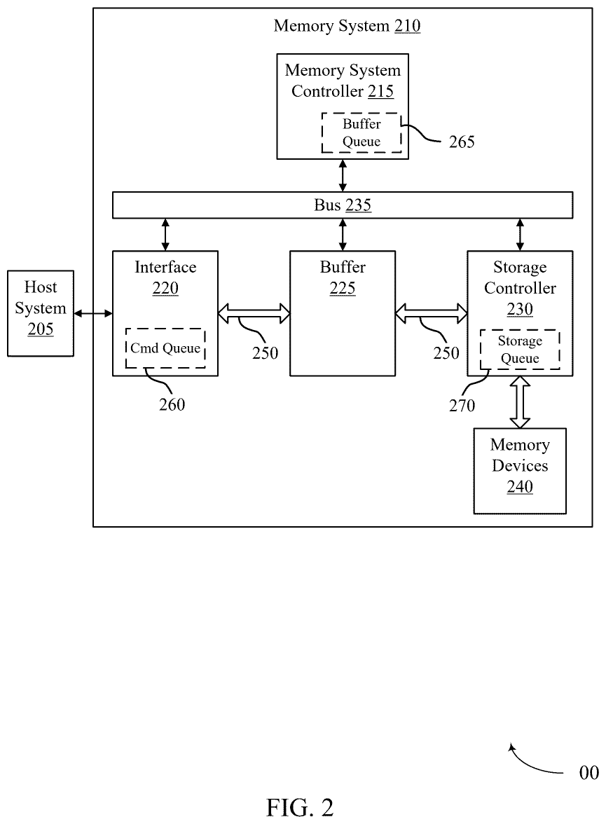

FIG. 2 shows an example of a system 200 that supports techniques for memory cell degradation protection in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some cases, a memory system 210 may perform a protection operation on blocks of memory cells to mitigate degradation. For example, the memory system 210 may monitor the temperature associated with the memory system 210 over a specific time frame.

If the temperature exceeds a certain threshold, a counter may be adjusted by a first value. If the counter exceeds a second threshold, the memory system 210 may trigger one or more protection operations on the blocks. These protection operations may involve programming a specific data pattern to each block, which may help mitigate degradation caused by exposure to high temperatures.

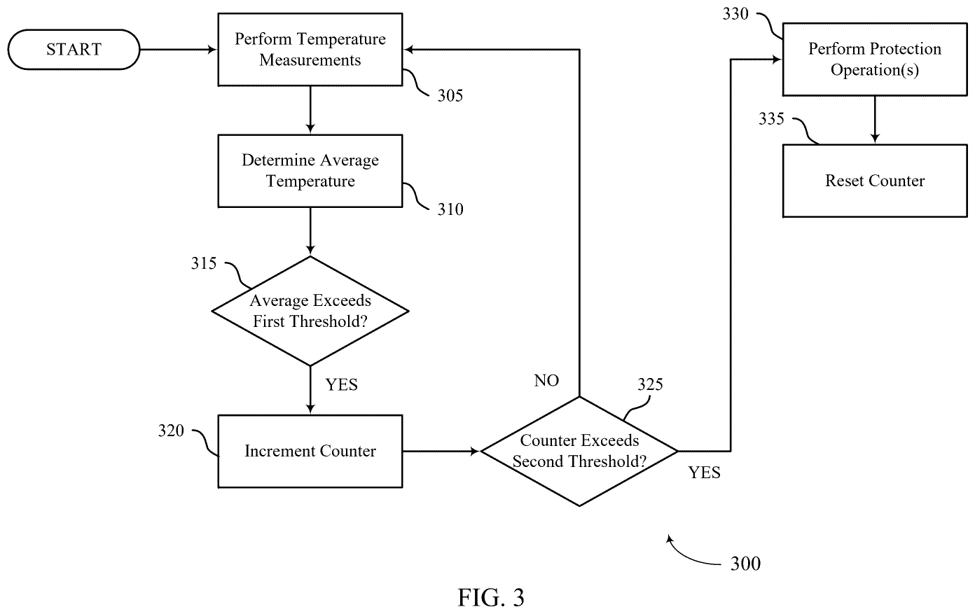

FIG. 3 shows an example of a process flow 300 that supports techniques for memory cell degradation protection in accordance with examples as disclosed herein. In some examples, a memory system, which may be an example of the memory system 110 or the memory system 210 (or both) as described with reference to FIGS. 1 and 2, may implement aspects of the process flow 300 using a memory system controller (e.g., a memory system controller 115, a memory system controller 215). In the following description of process flow 300, the operations may be performed in a different order than the order shown. For example, specific operations may also be left out of process flow 300, or other operations may be added to process flow 300.

The process flow 300 may illustrate a method to monitor blocks of memory cells for repeated exposure to high temperatures, and to perform one or more protection operations on the blocks to mitigate degradation (e.g., read window budget degradation) due to the repeated exposure. For example, at 305, the memory system may perform a set of temperature measurements to monitor the temperature of the system. For example, the memory system may include one or more temperature sensors that allow the memory system to record temperature information, such as a temperature of one or more memory devices of the memory system, a temperature of one or more blocks of memory cells, or both.

The memory system may perform a quantity of measurements within a duration (e.g., a time frame) to obtain an accurate representation of the temperature. For example, the memory system may perform the quantity of measurements according to a periodicity over the duration (e.g., one measurement each millisecond). The memory system may store the measurements, such as by using a buffer. In some cases, the memory system may modify the quantity of measurements made in the duration (e.g., may modify the periodicity of the measurements), may modify the length of the duration, or both. For example, the memory system may receive a first command (e.g., from a host system) to configure the quantity of measurements, may receive a second command to configure the length of the duration, or both.

At 310, the memory system may calculate an average temperature of the memory system over the duration. For example, the memory system may calculate the average of the set of stored temperature measurements over the duration. In some cases, a relatively high average temperature may indicate that the memory system underwent an erase bake operation or similar operation within the duration, and accordingly that some blocks of memory cells within the memory system may be susceptible to degradation (e.g., permanent degradation of read window budget). An erase bake operation may refer to a period where an increase in temperature of the memory system may result in data being erased from a block of memory cells.

To mitigate potential degradation due to repeated exposure to high temperatures, the memory system may, at 315, determine whether the calculated average temperature satisfies a temperature threshold. For example, the memory system may compare the calculated average temperature to the temperature threshold. If the average temperature exceeds the temperature threshold, the memory system may, at 320, adjust a counter, such as by incrementing the counter, adding a value to the counter, or both. In some examples, the counter may be persistent through powering off the memory system. For example, the memory system may store the counter to one or more non-volatile memory cells of the memory system. Accordingly, after a power cycle of the memory system, the memory system may continue to manage the counter throughout operation of the memory system.

In some cases, the memory system may adjust the counter commensurate with the value of the average temperature. For example, the memory system may compare the average temperature with multiple temperature thresholds or may compare the average temperature with multiple temperature ranges. If the average temperature is within a first temperature range, the memory system may adjust the counter by a first value. Alternatively, if the average temperature is within a second temperature range higher than the first temperature range, the memory system may adjust the counter by a second value larger than the first value. In some cases, the memory system may modify the temperature threshold, the temperature ranges, or both. For example, the memory system may receive a command (e.g., from a host system) to configure the temperature threshold, the temperature ranges, or both.

At 325, the memory system may determine whether the counter satisfies a counter threshold. For example, the memory system may compare the value of the counter to the counter threshold. If the value of the counter exceeds the counter threshold, the process flow 300 may proceed to 330, and the memory system may perform one or more protection operations on block of memory cells of the memory system. Alternatively, if the value of the counter is less than the threshold, the process flow 300 may return to 305, and the memory system may continue iteratively performing a set of temperature measurements over a duration. In some cases, the memory system may modify the counter threshold. For example, the memory system may receive a command (e.g., from a host system) to configure the counter threshold.

At 330, the memory system may perform one or more protection operations on blocks of memory cells of the memory system. For example, the memory system may identify blocks of memory cells that may be susceptible to degradation due to repeated exposure to high temperatures. These blocks may include erased blocks (e.g., blocks of memory cells that are in an erased state), partially programmed blocks (e.g., closed blocks in which some pages have been programmed while other pages have not been programmed), and open blocks (e.g., blocks that are available to store data, in which some pages have been programmed with data while others remain unprogrammed). Performing a protection operation on a block may include writing a data pattern to the block (e.g., to unused pages of the block) that may protect the block from degradation due to repeated exposure to high temperatures. After performing the one or more protection operations, the memory system may, at 335, reset the counter to support additional iterations of the process flow 300.

The memory system may perform a first type of protection operation on erased blocks of the memory system. In some cases, the first type of protection operation may include performing an inverse erase or a special erase on an erased block. For example, to perform the first type of protection operation, the memory system may apply an erase bias to each page of memory cells of the block, which may store a first distribution of voltages to memory cells of the block. Subsequently, the memory system may apply a pre-program pulse to each page of memory cells of the block, which may store a second distribution of voltages to memory cells of the block. In some cases, the second distribution of voltages may span higher range of voltages than the first distribution of voltages. For example, the first distribution of voltages may correspond to an erased state, and the second distribution of voltages may correspond to an intermediate state.

As described herein, an intermediate state may refer a voltage distribution between two voltage distributions corresponding to consecutive logic states. By way of illustrative example, a block of memory cells may be an example of a TLC block. Accordingly, memory cells of the block may be configured to store one of eight possible logic states using corresponding voltage levels, such as a first logic state (e.g., a logical “000” state) corresponding to a first voltage level, a second logic state (e.g., a logical “001” state corresponding to a second voltage level higher than the first voltage level, and so on. Such memory cells may be programmed to an intermediate state by storing a voltage that is between voltage levels corresponding to consecutive logic states. For example, an intermediate state may correspond to a voltage level greater than the first voltage level associated with the first logic state and less than the second voltage level associated with the second logic state.

Additionally, the memory system may perform a second type of protection operation on partially programmed blocks of the memory system. In some cases, the second type of protection operation may include performing a padding operation on a partially programmed block. For example, to perform the second type of protection operation, the memory system may apply a pulse to unprogrammed pages of a partially programmed block (e.g., apply a voltage to word lines associated with the unprogrammed pages) and may refrain applying a pulse to programmed pages of a partially programmed block. Applying the pulse to the unprogrammed pages may store a voltage distribution to these pages, which may support mitigating degradation due to repeated exposure to high temperatures. In some examples, the voltage distribution may be relatively broad compared to voltage distributions of programmed pages. For example, applying the pulse may store a voltage distribution having a range of voltages that includes multiple logic states. Additionally, the memory system may apply the pulse to each of the word lines associated with the unprogrammed pages concurrently (e.g., rather than applying the pulse to each word line one by one).

Additionally, the memory system may perform a third type of protection operation on open blocks of the memory system. In some cases, the third type of protection operation may include closing each open block of memory cells, and thus converting each open block of memory cells to a partially programmed block, and subsequently performing the second type of protection operation (e.g., performing a padding operation) on the converted blocks.

In some cases, the memory system may prioritize other operations (e.g., memory management operations, operations associated with host commands) over the one or more protection operations. For example, after identifying the blocks of memory cells on which to perform the protection operations, the memory system may store the protection operations (e.g., commands associated with the protection operations) to a queue and may perform the protection operations after a duration (e.g., during an idle period of the memory system). Additionally, the memory system may prioritize different types of protection operations over other types. For example, the memory system may prioritize the first type of protection operation for erased blocks over the second type of protection operation for partially programmed blocks and may prioritize the second type of protection operation over the third type of protection operation for open blocks.

In some cases, the memory system may implement the process flow 300 on finer granularities, such as on a per-block level. For example, for each block that has become erased, partially programmed, or open, the memory system may monitor a temperature of the block (e.g., using a respective temperature sensor) and determine whether an average temperature (e.g., averaged over a duration) of the block exceeds a temperature threshold. If the average temperature of the block exceeds the temperature threshold, the memory system may adjust the value of a block-specific counter. If the value of the block-specific counter exceeds a counter threshold, the memory system may perform a protection operation (e.g., the first type of protection operation if the block is an erased block, the second type of protection operation if the block is a partially programmed block, or the third type of protection operation if the block is an open block) for that block.

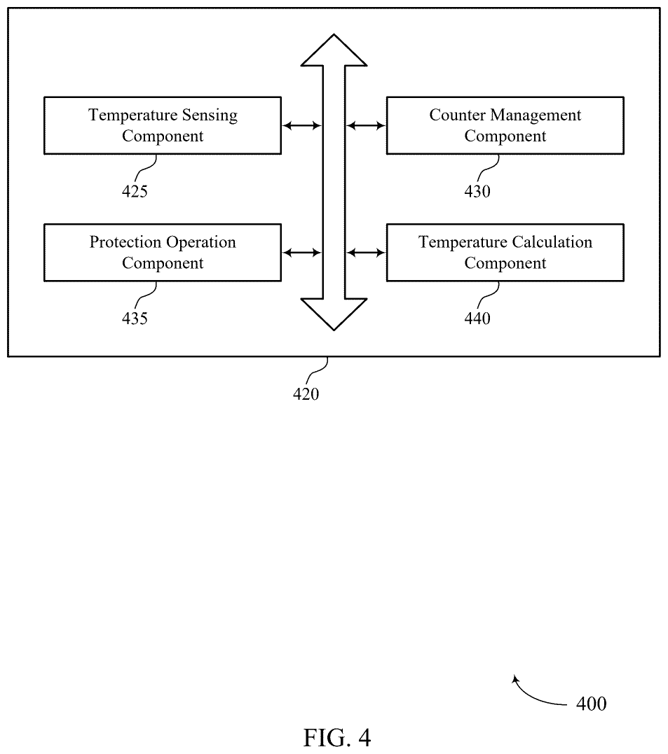

FIG. 4 shows a block diagram 400 of a memory system 420 that supports techniques for memory cell degradation protection in accordance with examples as disclosed herein. The memory system 420 may be an example of aspects of a memory system as described with reference to FIGS. 1 through 3. The memory system 420, or various components thereof, may be an example of means for performing various aspects of techniques for memory cell degradation protection as described herein. For example, the memory system 420 may include a temperature sensing component 425, a counter management component 430, a protection operation component 435, a temperature calculation component 440, or any combination thereof. Each of these components, or components of subcomponents thereof (e.g., one or more processors, one or more memories), may communicate, directly or indirectly, with one another (e.g., via one or more buses).

The temperature sensing component 425 may be configured as or otherwise support a means for monitoring a temperature associated with the memory system. The counter management component 430 may be configured as or otherwise support a means for adjusting a counter by a first value based at least in part on the temperature satisfying a first threshold. The protection operation component 435 may be configured as or otherwise support a means for performing one or more protection operations on one or more blocks of memory cells of the memory system based at least in part on the counter satisfying a second threshold, the one or more protection operations including programming a respective data pattern to each of the one or more blocks of memory cells.

In some examples, to support monitoring the temperature, the temperature sensing component 425 may be configured as or otherwise support a means for performing a plurality of temperature measurements of the memory system over a duration. In some examples, to support monitoring the temperature, the temperature calculation component 440 may be configured as or otherwise support a means for determining an average temperature for the duration based at least in part on the plurality of temperature measurements, where the temperature includes the average temperature.

In some examples, the temperature calculation component 440 may be configured as or otherwise support a means for modifying a quantity of the plurality of temperature measurements made in the duration, where performing the plurality of temperature measurements is based at least in part on modifying the quantity.

In some examples, the temperature sensing component 425 may be configured as or otherwise support a means for modifying the duration over which measurements are taken, where performing the plurality of temperature measurements is based at least in part on modifying the duration.

In some examples, to support performing the one or more protection operations, the protection operation component 435 may be configured as or otherwise support a means for performing a first type of protection operation on one or more erased blocks of the one or more blocks of memory cells. In some examples, to support performing the one or more protection operations, the protection operation component 435 may be configured as or otherwise support a means for performing a second type of protection operation on one or more partially filled blocks of the one or more blocks of memory cells. In some examples, to support performing the one or more protection operations, the protection operation component 435 may be configured as or otherwise support a means for performing a third type of protection operation on one or more open blocks of the one or more blocks of memory cells.

In some examples, to support second type of protection operation, the protection operation component 435 may be configured as or otherwise support a means for writing a data pattern to one or more unprogrammed pages of the one or more partially filled blocks.

In some examples, to support second type of protection operation, the protection operation component 435 may be configured as or otherwise support a means for refraining from writing the data pattern to one or more programmed pages of the one or more partially filled blocks.

In some examples, to support second type of protection operation, the protection operation component 435 may be configured as or otherwise support a means for concurrently activating a plurality of word lines corresponding to the one or more unprogrammed pages.

In some examples, to support programming a respective data pattern, the protection operation component 435 may be configured as or otherwise support a means for programming a first voltage to a memory cell of the one or more blocks of memory cells, where the first voltage is different than a second voltage corresponding to a first logic state of the memory cell and the first voltage is different than a third voltage corresponding to a second logic state of the memory cell.

In some examples, the temperature sensing component 425 may be configured as or otherwise support a means for monitoring a second temperature associated with the memory system. In some examples, the counter management component 430 may be configured as or otherwise support a means for adjusting the counter by a second value greater than the first value based at least in part on the second temperature satisfying a third threshold greater than the first threshold, where performing the one or more protection operations is based at least in part on adjusting the counter by the second value.

In some examples, the temperature sensing component 425 may be configured as or otherwise support a means for monitoring a second temperature of a block of the one or more blocks of memory cells. In some examples, the counter management component 430 may be configured as or otherwise support a means for adjusting a second counter based at least in part on the second temperature satisfying a third threshold. In some examples, the protection operation component 435 may be configured as or otherwise support a means for performing one or more second protection operations on the block based at least in part on the second counter satisfying a fourth threshold.

In some examples, the counter management component 430 may be configured as or otherwise support a means for storing a value of the counter to a non-volatile portion of the memory system based at least in part on adjusting the counter. In some examples, the counter management component 430 may be configured as or otherwise support a means for performing a power cycle operation after storing the value of the counter.

In some examples, the counter management component 430 may be configured as or otherwise support a means for resetting the counter based at least in part on performing the one or more protection operations.

In some examples, the counter management component 430 may be configured as or otherwise support a means for modifying a parameter corresponding to the first threshold, where adjusting the counter is based at least in part on modifying the parameter.

In some examples, the counter management component 430 may be configured as or otherwise support a means for modifying a parameter corresponding to the second threshold, where performing the one or more protection operations is based at least in part on modifying the parameter.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

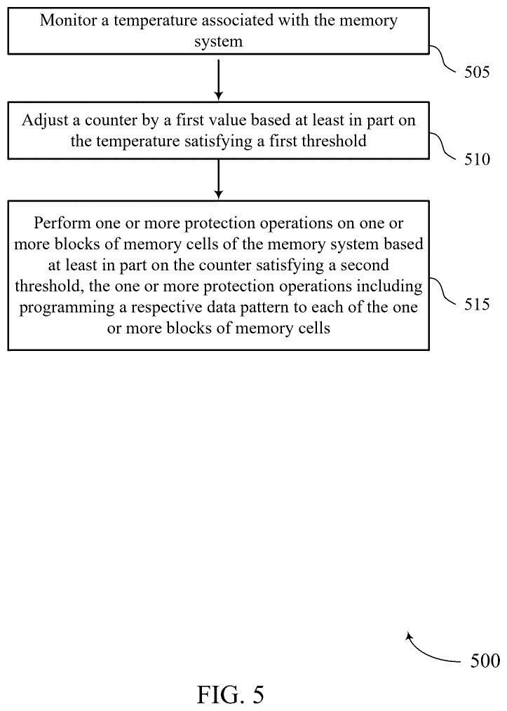

FIG. 5 shows a flowchart illustrating a method 500 that supports techniques for memory cell degradation protection in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include monitoring a temperature associated with the memory system. In some examples, aspects of the operations of 505 may be performed by a temperature sensing component 425 as described with reference to FIG. 4.

At 510, the method may include adjusting a counter by a first value based at least in part on the temperature satisfying a first threshold. In some examples, aspects of the operations of 510 may be performed by a counter management component 430 as described with reference to FIG. 4.

At 515, the method may include performing one or more protection operations on one or more blocks of memory cells of the memory system based at least in part on the counter satisfying a second threshold, the one or more protection operations including programming a respective data pattern to each of the one or more blocks of memory cells. In some examples, aspects of the operations of 515 may be performed by a protection operation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for monitoring a temperature associated with the memory system; adjusting a counter by a first value based at least in part on the temperature satisfying a first threshold; and performing one or more protection operations on one or more blocks of memory cells of the memory system based at least in part on the counter satisfying a second threshold, the one or more protection operations including programming a respective data pattern to each of the one or more blocks of memory cells.

Aspect 2: The method, apparatus, or non-transitory computer-readable medium of aspect 1, where monitoring the temperature includes operations, features, circuitry, logic, means, or instructions, or any combination thereof for performing a plurality of temperature measurements of the memory system over a duration and determining an average temperature for the duration based at least in part on the plurality of temperature measurements, where the temperature includes the average temperature.

Aspect 3: The method, apparatus, or non-transitory computer-readable medium of aspect 2, further including operations, features, circuitry, logic, means, or instructions, or any combination thereof for modifying a quantity of the plurality of temperature measurements made in the duration, where performing the plurality of temperature measurements is based at least in part on modifying the quantity.

Aspect 4: The method, apparatus, or non-transitory computer-readable medium of any of aspects 2 through 3, further including operations, features, circuitry, logic, means, or instructions, or any combination thereof for modifying the duration over which measurements are taken, where performing the plurality of temperature measurements is based at least in part on modifying the duration.

Aspect 5: The method, apparatus, or non-transitory computer-readable medium of any of aspects 1 through 4, where performing the one or more protection operations includes operations, features, circuitry, logic, means, or instructions, or any combination thereof for performing a first type of protection operation on one or more erased blocks of the one or more blocks of memory cells; performing a second type of protection operation on one or more partially filled blocks of the one or more blocks of memory cells; and performing a third type of protection operation on one or more open blocks of the one or more blocks of memory cells.

Aspect 6: The method, apparatus, or non-transitory computer-readable medium of aspect 5, where the second type of protection operation includes operations, features, circuitry, logic, means, or instructions, or any combination thereof for writing a data pattern to one or more unprogrammed pages of the one or more partially filled blocks.

Aspect 7: The method, apparatus, or non-transitory computer-readable medium of aspect 6, where the second type of protection operation further includes operations, features, circuitry, logic, means, or instructions, or any combination thereof for refraining from writing the data pattern to one or more programmed pages of the one or more partially filled blocks.

Aspect 8: The method, apparatus, or non-transitory computer-readable medium of any of aspects 6 through 7, where the second type of protection operation further includes operations, features, circuitry, logic, means, or instructions, or any combination thereof for concurrently activating a plurality of word lines corresponding to the one or more unprogrammed pages.

Aspect 9: The method, apparatus, or non-transitory computer-readable medium of any of aspects 1 through 8, where programming a respective data pattern includes operations, features, circuitry, logic, means, or instructions, or any combination thereof for programming a first voltage to a memory cell of the one or more blocks of memory cells, where the first voltage is different than a second voltage corresponding to a first logic state of the memory cell and the first voltage is different than a third voltage corresponding to a second logic state of the memory cell.

Aspect 10: The method, apparatus, or non-transitory computer-readable medium of any of aspects 1 through 9, further including operations, features, circuitry, logic, means, or instructions, or any combination thereof for monitoring a second temperature associated with the memory system and adjusting the counter by a second value greater than the first value based at least in part on the second temperature satisfying a third threshold greater than the first threshold, where performing the one or more protection operations is based at least in part on adjusting the counter by the second value.

Aspect 11: The method, apparatus, or non-transitory computer-readable medium of any of aspects 1 through 10, further including operations, features, circuitry, logic, means, or instructions, or any combination thereof for monitoring a second temperature of a block of the one or more blocks of memory cells; adjusting a second counter based at least in part on the second temperature satisfying a third threshold; and performing one or more second protection operations on the block based at least in part on the second counter satisfying a fourth threshold.

Aspect 12: The method, apparatus, or non-transitory computer-readable medium of any of aspects 1 through 11, further including operations, features, circuitry, logic, means, or instructions, or any combination thereof for storing a value of the counter to a non-volatile portion of the memory system based at least in part on adjusting the counter and performing a power cycle operation after storing the value of the counter.

Aspect 13: The method, apparatus, or non-transitory computer-readable medium of any of aspects 1 through 12, further including operations, features, circuitry, logic, means, or instructions, or any combination thereof for resetting the counter based at least in part on performing the one or more protection operations.

Aspect 14: The method, apparatus, or non-transitory computer-readable medium of any of aspects 1 through 13, further including operations, features, circuitry, logic, means, or instructions, or any combination thereof for modifying a parameter corresponding to the first threshold, where adjusting the counter is based at least in part on modifying the parameter.

Aspect 15: The method, apparatus, or non-transitory computer-readable medium of any of aspects 1 through 14, further including operations, features, circuitry, logic, means, or instructions, or any combination thereof for modifying a parameter corresponding to the second threshold, where performing the one or more protection operations is based at least in part on modifying the parameter.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
monitoring a temperature associated with the memory system;
adjusting a counter by a first value based at least in part on the temperature satisfying a first threshold; and
performing one or more protection operations on one or more blocks of memory cells of the memory system based at least in part on the counter satisfying a second threshold, the one or more protection operations comprising programming a respective data pattern to each of the one or more blocks of memory cells.

2. The method of claim 1, wherein monitoring the temperature comprises:
performing a plurality of temperature measurements of the memory system over a duration; and
determining an average temperature for the duration based at least in part on the plurality of temperature measurements, wherein the temperature comprises the average temperature.

3. The method of claim 2, further comprising:
modifying a quantity of the plurality of temperature measurements made in the duration, wherein performing the plurality of temperature measurements is based at least in part on modifying the quantity.

4. The method of claim 2, further comprising:
modifying the duration over which measurements are taken, wherein performing the plurality of temperature measurements is based at least in part on modifying the duration.

5. The method of claim 1, wherein performing the one or more protection operations comprises:
performing a first type of protection operation on one or more erased blocks of the one or more blocks of memory cells;
performing a second type of protection operation on one or more partially filled blocks of the one or more blocks of memory cells; and
performing a third type of protection operation on one or more open blocks of the one or more blocks of memory cells.

6. The method of claim 5, wherein the second type of protection operation comprises:
writing a data pattern to one or more unprogrammed pages of the one or more partially filled blocks.

7. The method of claim 6, wherein the second type of protection operation further comprises:
refraining from writing the data pattern to one or more programmed pages of the one or more partially filled blocks.

8. The method of claim 6, wherein the second type of protection operation further comprises:
concurrently activating a plurality of word lines corresponding to the one or more unprogrammed pages.

9. The method of claim 1, wherein programming a respective data pattern comprises:
programming a first voltage to a memory cell of the one or more blocks of memory cells, wherein the first voltage is different than a second voltage corresponding to a first logic state of the memory cell and the first voltage is different than a third voltage corresponding to a second logic state of the memory cell.

10. The method of claim 1, further comprising:
monitoring a second temperature associated with the memory system; and
adjusting the counter by a second value greater than the first value based at least in part on the second temperature satisfying a third threshold greater than the first threshold, wherein performing the one or more protection operations is based at least in part on adjusting the counter by the second value.

11. The method of claim 1, further comprising:
monitoring a second temperature of a block of the one or more blocks of memory cells;
adjusting a second counter based at least in part on the second temperature satisfying a third threshold; and
performing one or more second protection operations on the block based at least in part on the second counter satisfying a fourth threshold.

12. The method of claim 1, further comprising:
storing a value of the counter to a non-volatile portion of the memory system based at least in part on adjusting the counter; and
performing a power cycle operation after storing the value of the counter.

13. The method of claim 1, further comprising:
resetting the counter based at least in part on performing the one or more protection operations.

14. The method of claim 1, further comprising:
modifying a parameter corresponding to the first threshold, wherein adjusting the counter is based at least in part on modifying the parameter.

15. The method of claim 1, further comprising:
modifying a parameter corresponding to the second threshold, wherein performing the one or more protection operations is based at least in part on modifying the parameter.

16. A memory system, comprising:
one or more memory devices; and
processing circuitry coupled with the one or more memory devices and configured to cause the memory system to:
monitor a temperature associated with the memory system;
adjust a counter by a first value based at least in part on the temperature satisfying a first threshold; and
perform one or more protection operations on one or more blocks of memory cells of the memory system based at least in part on the counter satisfying a second threshold, the one or more protection operations comprising programming a respective data pattern to each of the one or more blocks of memory cells.

17. The memory system of claim 16, wherein monitoring the temperature comprises the processing circuitry configured to cause the memory system to:
perform a plurality of temperature measurements of the memory system over a duration; and
determine an average temperature for the duration based at least in part on the plurality of temperature measurements, wherein the temperature comprises the average temperature.

18. The memory system of claim 17, wherein the processing circuitry is further configured to cause the memory system to:
modify a quantity of the plurality of temperature measurements made in the duration, wherein performing the plurality of temperature measurements is based at least in part on modifying the quantity.

19. The memory system of claim 17, wherein the processing circuitry is further configured to cause the memory system to:
modify the duration over which measurements are taken, wherein performing the plurality of temperature measurements is based at least in part on modifying the duration.

20. The memory system of claim 16, wherein performing the one or more protection operations comprises the processing circuitry configured to cause the memory system to:
perform a first type of protection operation on one or more erased blocks of the one or more blocks of memory cells;
perform a second type of protection operation on one or more partially filled blocks of the one or more blocks of memory cells; and
perform a third type of protection operation on one or more open blocks of the one or more blocks of memory cells.

21. The memory system of claim 20, wherein the second type of protection operation comprises the processing circuitry configured to cause the memory system to write a data pattern to one or more unprogrammed pages of the one or more partially filled blocks.

22. The memory system of claim 21, wherein the second type of protection operation further comprises the processing circuitry configured to cause the memory system to refrain from writing the data pattern to one or more programmed pages of the one or more partially filled blocks.

23. The memory system of claim 21, wherein the second type of protection operation further comprises the processing circuitry configured to cause the memory system to concurrently activate a plurality of word lines corresponding to the one or more unprogrammed pages.

24. The memory system of claim 16, wherein programming a respective data pattern comprises the processing circuitry configured to cause the memory system to:
program a first voltage to a memory cell of the one or more blocks of memory cells, wherein the first voltage is different than a second voltage corresponding to a first logic state of the memory cell and the first voltage is different than a third voltage corresponding to a second logic state of the memory cell.

25. A non-transitory computer-readable medium storing code, the code comprising instructions executable by one or more processors to:
monitor a temperature associated with a memory system;
adjust a counter by a first value based at least in part on the temperature satisfying a first threshold; and
perform one or more protection operations on one or more blocks of memory cells of the memory system based at least in part on the counter satisfying a second threshold, the one or more protection operations comprising programming a respective data pattern to each of the one or more blocks of memory cells.
